(19) United States
(12) Patent Application Publication
(10) Pub. No.: US 2008/0105747 A1
(43) Pub. Date: May 8, 2008

(54) System and method for selecting a portion of an image

(76) Inventor: Mark P. Orlassino, Centereach, NY (US)

Correspondence Address: FAY KAPLUN & MARCIN, LLP, 150 BROADWAY, SUITE 702, NEW YORK, NY, 10038, US

(21) Appl. No.: 11/592,871

(22) Filed: Nov. 3, 2006

(51) Int. Cl. G06K 7/10

(52) U.S. Cl. 235/462.41

(57) ABSTRACT

Described is a system and method for selecting a portion of an image. The method comprises obtaining a first image by an image capture device, analyzing the first image to detect at least one predetermined object therein, generating a second image as a function of the first image, the second image including at least one portion of the first image, the at least one portion including the at least one predetermined object, selecting one of the portions and performing a predetermined operation on the selected portion.

### FIELD OF INVENTION

The present application generally relates to systems and methods for selecting a portion of an image captured by an image capture device.

### BACKGROUND INFORMATION

Many mobile computing devices (e.g., scanners, PDAs, mobile phones, laptops, mp3 players, etc.) include digital cameras to extend their functionalities. For example, an imager-based barcode reader may utilize a digital camera for capturing images of barcodes, which come in various forms, such as parallel lines, patterns of dots, concentric circles, hidden images, etc.), both one dimensional (1D) and two dimensional (2D).

The imager-based barcode reader typically provides a display screen which presents a preview of an imaging field of the imager. Thus, a user may visually confirm that a barcode will be included in an image generated by the imager. Even though conventional decoders can locate and decode bar codes regardless of location within the image, users typically think that the barcode must be centered within the image for the barcode to be decoded properly. In addition, users typically think that the barcode must be large within the image to be decoded properly, and, as a result, place the imager-based barcode reader extremely close to the barcode. However, the conventional decoders can decode barcodes that are relatively small within the image. Therefore, between orienting the barcode in the display and manually zooming, capturing the image may prove to be unnecessarily time consuming.

### SUMMARY OF THE INVENTION

The present invention relates to a system and method for selecting a portion of an image. The method comprises obtaining a first image by an image capture device, analyzing the first image to detect at least one predetermined object therein, generating a second image as a function of the first image, the second image including at least one portion of the first image, the at least one portion including the at least one predetermined object, selecting one of the portions and performing a predetermined operation on the selected portion.

### BRIEF DESCRIPTION OF THE DRAWINGS

FIG. 1 illustrates an exemplary embodiment of an image capture device according to the present invention.

FIG. 2 illustrates an exemplary embodiment of a method according to the present invention.

FIG. 3a illustrates an exemplary embodiment of an image capture device capturing multiple images according to the present invention.

FIG. 3b illustrates an exemplary embodiment of a preview image generated by an image capture device according to the present invention.

FIG. 4a illustrates an exemplary embodiment of a summary image generated by an image capture device according to the present invention.

FIG. 4b illustrates another exemplary embodiment of a summary image generated by an image capture device according to the present invention.

FIG. 5a illustrates another exemplary embodiment of a preview image generated by an image capture device according to the present invention.

FIG. 5b illustrates another exemplary embodiment of a summary image generated by an image capture device according to the present invention.

FIG. 6a illustrates a further exemplary embodiment of a preview image generated by an image capture device according to the present invention.

FIG. 6b illustrates an exemplary embodiment of a position determining function according to the present invention.

FIG. 6c illustrates another exemplary embodiment of a position determining function according to the present invention.

### DETAILED DESCRIPTION

The present invention may be further understood with reference to the following description and appended drawings, wherein like elements are provided with the same reference numerals. The exemplary embodiments of the present invention describe a system and method for selecting a portion of an image captured by an image capture device. In the exemplary embodiment, the image capture device detects a predetermined object (e.g., barcodes, signatures, shipping labels, dataforms, etc.) in the image and allows a user to select one or more of the items for additional processing, as will be described below.

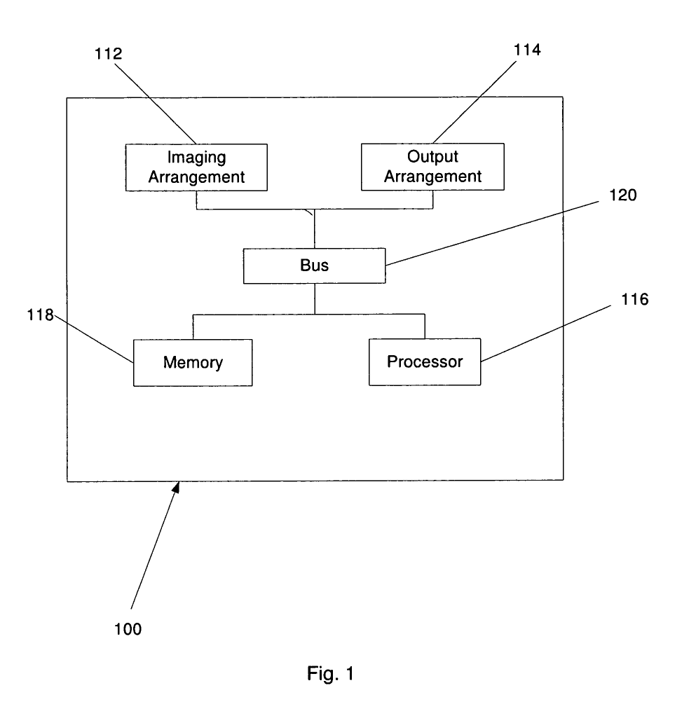

FIG. 1 illustrates an exemplary embodiment of an image capture device 100 according to the present invention. The device 100 may be implemented as any processor-based device such as, for example, an imager-based scanner, an RFID reader, a mobile phone, a laptop, a PDA, a digital camera, a digital media player, a tablet computer, a handheld computer, etc. In the exemplary embodiment, the device 100 includes an imaging arrangement 112, an output arrangement 114, a processor 116 and a memory 118, which are interconnected via a bus 120. Those of skill in the art will understand that the device 100 may include various other components such as, for example, a wireless communication arrangement, a user interface device, etc. for accomplishing tasks for which the device 100 is intended. The components of the device 100 may be implemented in software and/or hardware. In other exemplary embodiments, the output arrangement 114, the processor 116 and/or the memory 118 may be located remotely from the device 100, e.g., in a remote computing device. In these embodiments, the device 100 may capture an image and transmit data comprising the image to the remote computing device for processing and/or display of the image.

The processor 116 may comprise a central processing unit (CPU) or other processing arrangement (e.g., a field programmable gate array) for executing instructions stored in the memory 118 and controlling operation of other components of the device 100. The memory 118 may be implemented as any combination of volatile memory, non-volatile memory and/or rewritable memory, such as, for example, Random Access Memory (RAM), Read Only Memory (ROM) and/or flash memory. The memory 118 stores instructions used to operate and data generated by the device 100. For example, the memory 118 may comprise an operating system and a signal processing method (e.g., image capture method, image decoding method, etc.). The memory 118 may also store image data corresponding to images previously captured by the imaging arrangement 112.

The imaging arrangement 112 (e.g., a digital camera) may be used to capture an image (monochrome and/or color). The output arrangement 114 (e.g., a liquid crystal display, a projection display, etc.) may be used to view a preview of the image prior to capture and/or play back of previously captured images. The preview outputted on the output arrangement 114 may be updated in real-time, providing visual confirmation to a user that an image captured by the imaging arrangement 112 would include the item of interest, e.g., a predetermined object. The imaging arrangement 112 may be activated by signals received from a user input arrangement (not shown) such as, for example, a keypad, a keyboard, a touch screen, a trigger, a track wheel, a spatial orientation sensor, an accelerometer, a MEMS sensor, a microphone and a mouse.

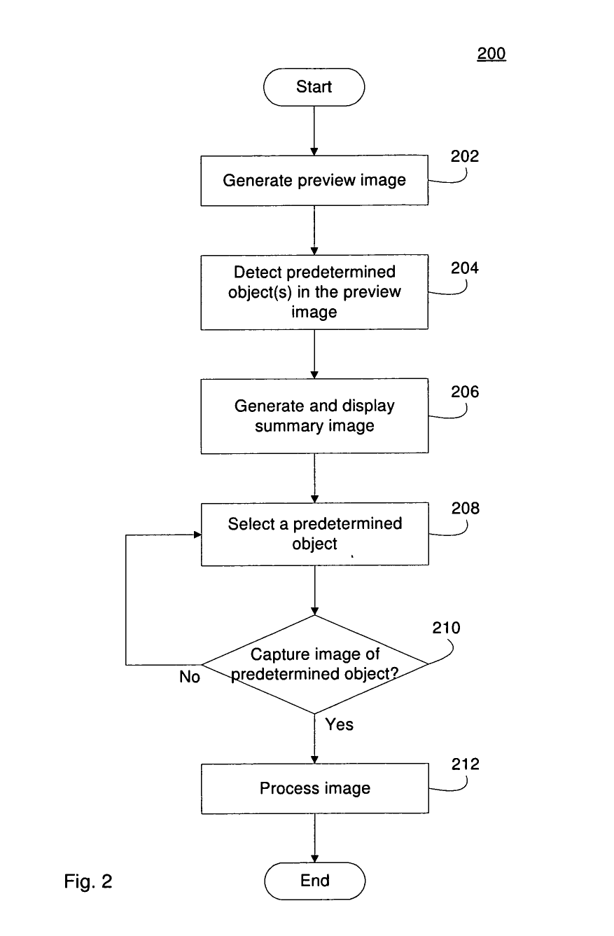

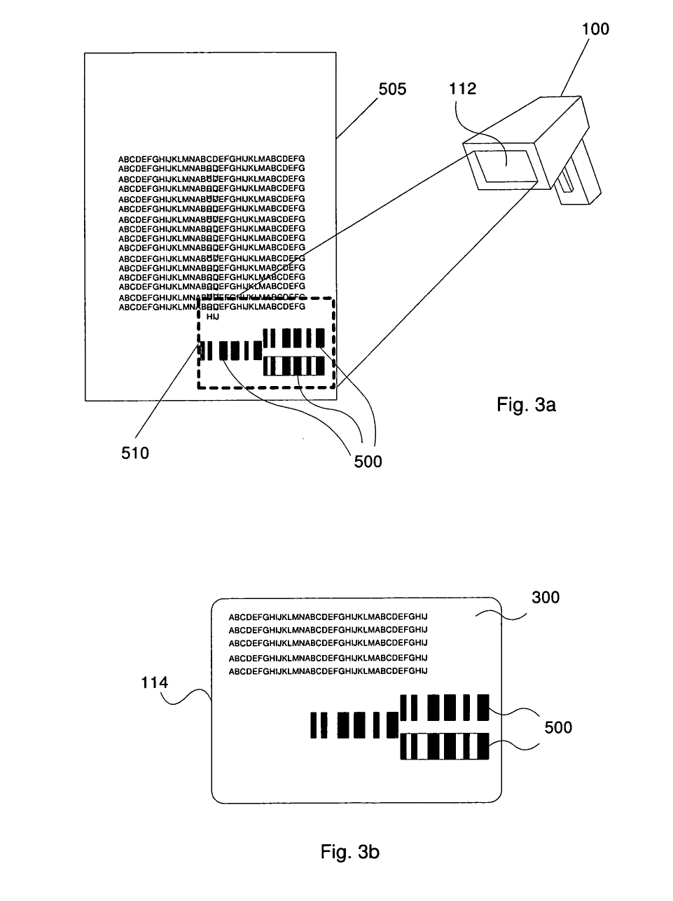

FIG. 2 shows an exemplary embodiment of a method 200 for selecting a portion(s) of an image according to the present invention. In step 202, a preview image 300 is generated and displayed on the output arrangement 114. FIG. 3a shows a schematic view of the device 100 being aimed at an item 505 including at least one predetermined object (e.g., barcodes 500), and FIG. 3b shows the preview image 300 as displayed on the output arrangement 114. As described above, the preview image 300 may be updated in real-time. The preview image 300 presents an image of items included in a field of view of the imaging arrangement 112. Thus, the preview image 300 includes a portion of the item 505 as well as the barcodes 500 disposed thereon.

In step 204, the processor 116 analyzes the preview image 300 to detect the predetermined object(s) therein. For example, in the exemplary embodiment, the processor 116 may be configured to detect decodable dataforms. Thus, the processor 116 detects the three barcodes 505 in the preview image 300 and ignores any portion of the preview image 300 which does not include decodable dataforms. Those of skill in the art will understand that the processor 116 may be configured to detect any predetermined object in the preview image 300 including, but not limited to, barcodes, shipping labels, signatures, etc. In another exemplary embodiment, the processor 116 may generate and analyze the preview image 300 in the background, without displaying the preview image 300 on the output arrangement 114. Thus, the processor 116 may continually generate and analyze successive preview image to identify the predetermined objects therein.

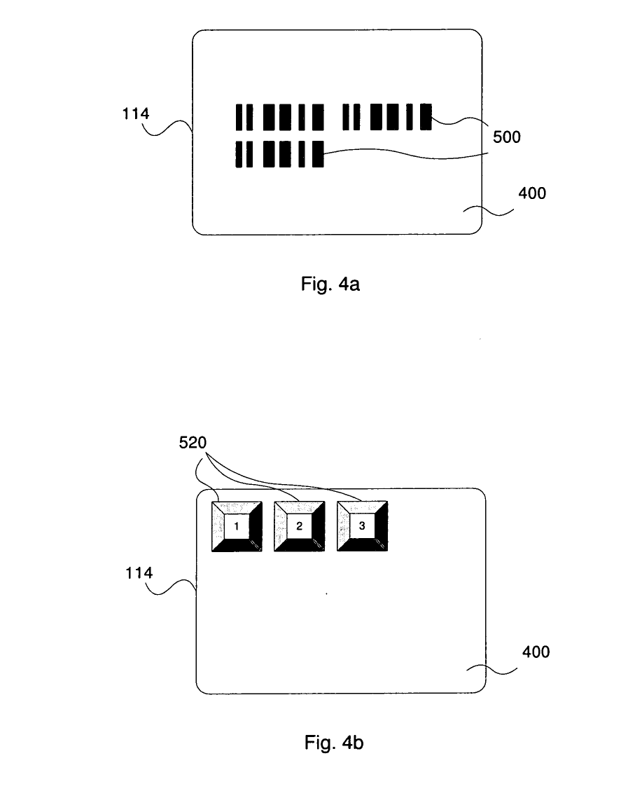

In step 206, the processor 116 generates a summary image 400 comprising the predetermined object(s) detected in the preview image 300 and displays the summary image 400 on the output arrangement 114. FIG. 4 shows an exemplary embodiment of the summary image 400 generated from the preview image 300 shown in FIG. 3b. The summary image 400 may be generated based upon a first user input. For example, the user of the device 100 may depress a button/trigger, touch a touch screen, etc., and the processor 116 may generate the summary image 400 by selecting a portion(s) of the preview image 300 which include the predetermined object(s). As shown in FIG. 4a, upon receiving the user input, the processor 116 may align, group, center, rotate and/or enlarge the barcodes 500 or images to generate the summary image 400.

In another exemplary embodiment, as shown in FIG. 4b, the processor 116 may generate a spatially decimated frame for each of the predetermined objects in the summary image 400. For example, a thumbnail image 520 may be generated for each of the predetermined objects detected in the preview image 300. Thus, the summary image 400 would simply include the thumbnail images 520 corresponding to the barcodes 500 detected in the preview image 300.

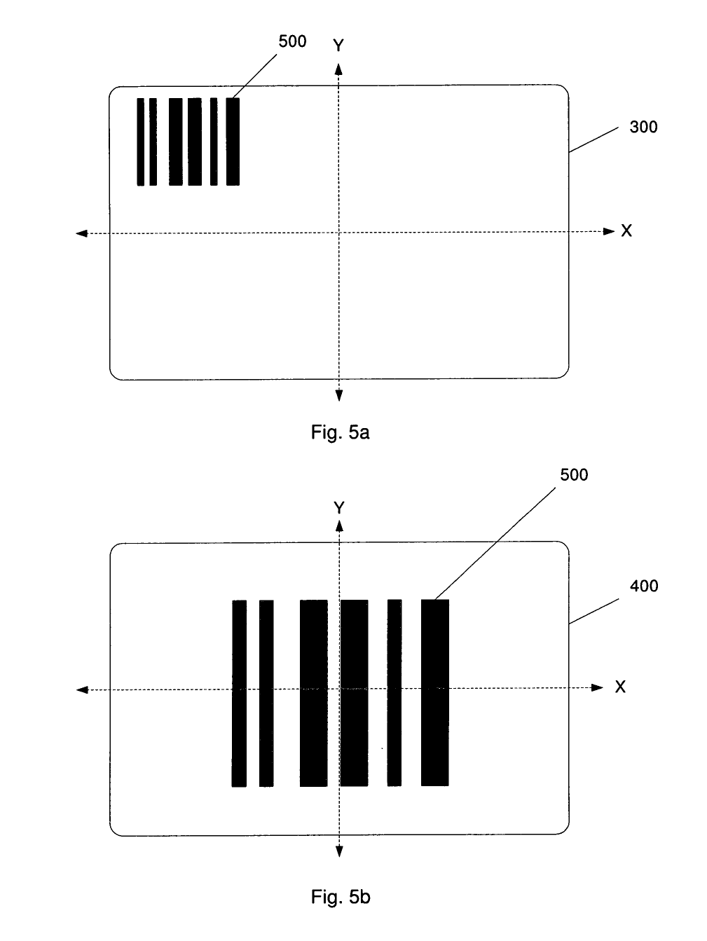

As understood by those of skill in the art, when the processor 116 only detects a single predetermined object in the preview image 300, the object may be rotated, centered and/or enlarged in the summary image 400. For example, as shown in FIG. 5a, the preview image 300 includes the barcode 500 in an upper, left-hand corner thereof. The processor 116 may then rotate, center and/or enlarge the barcode 500 in the summary image 400. That is, as shown in FIG. 5b, the barcode 500 may be positioned in a Cartesian center of the summary image 400 regardless of where the object is located in the preview image 300. In this manner, the user may not waste time manually reorienting the device 100 to reposition and/or enlarge the object within the preview image 300.

In step 208, one or more of the predetermined objects in the summary image 400 is selected. In the exemplary embodiment, a selector may be shown on the output arrangement 114 and movable between the predetermined objects. For example, the selector may be a cursor, highlight, crosshair, etc. which the user can movably position over the predetermined objects using a second user input, e.g., a keystroke, a tactile input a gesture input, a voice command, trigger squeeze or other user interface action. Those of skill in the art will understand that when the summary image 400 only includes a single predetermined object, the step 208 may be eliminated from the method 200. In another exemplary embodiment, the processor 116 may select one or more the predetermined objects automatically. That is, the processor 116 may be configured/defaulted to select a predetermined type of the predetermined objects. For example, the processor 116 may identify a UPC barcode and a EAN barcode on the item 505, but be configured to select only the UPC barcode for decoding.

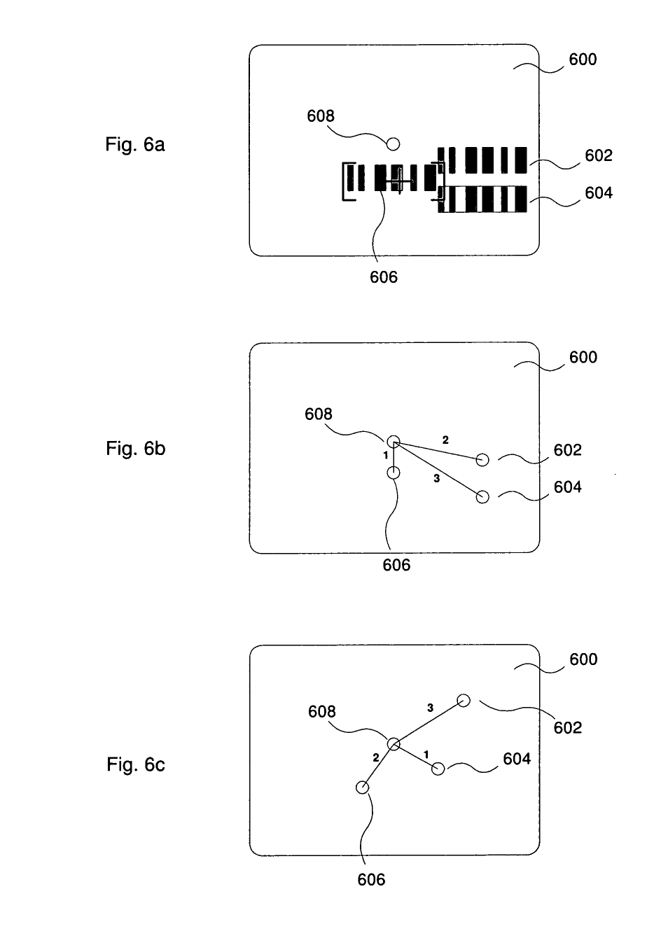

In another exemplary embodiment, the processor 116 may detect properties, positions, etc. of the predetermined objects and position the selector over a selected one of the objects based thereon. For example, as shown in FIGS. 6a-c, the processor 116 may determine a position of each of the objects relative to a center of the preview image and position the selector over an object closest to the center. As shown in FIG. 6a, the processor 116 detects barcodes 602-606 in a preview image 600. The processor 116 also identifies a root node 608 of the preview image 600 which is located at, for example, a Cartesian center thereof. The processor 116 then identifies a center node (e.g., geometric center) of each of the barcodes 602-606 and measures a distance between the root node 608 and each of the center nodes. Based on a comparison of the distances, the processor 116 assigns a weight to each of the barcodes 602-606, as shown in FIG. 6b, and positions the selector (e.g., a crosshair and/or brackets as shown in FIG. 6a) over the barcode with the weight that indicates that the barcode is closest to the root node 608. For example, as shown in FIG. 6b, the barcode 606 is assigned a weight of one, because it is closest to the root node 608. Thus, the processor 116 may position the selector over the barcode 606 either in the preview image or in the summary image. FIG. 6c shows how the distances between the barcodes 602-606 and the root node 608 and the resultant weights may change if the orientation of the imaging arrangement 112 with respect to the imaged object is changed.

In step 210, the processor 116 determines whether the selected predetermined object(s) should be captured. In the exemplary embodiment, the processor 116 may detect a third user input indicative of the user's desire to capture the selected predetermined object(s). An exemplary image preview, selection and capture process may be conducted as follows: the user may squeeze and release a trigger on the device 100 once to generate the summary image 400. A second squeeze of the trigger moves the selector over the predetermined objects shown in the summary image 400, and a third squeeze of the trigger selects and captures the image of the predetermined object. If the processor 116 does not detect the third user input, the user may continue to move the selector over the predetermined objects.

In step 212, the processor 116 detects the third user input, captures the preview image or a selected portion thereof which includes the predetermined object and processes the captured image. The processing may include storing the captured image in memory, inputting the captured image into a decoder and/or another image processing element/algorithm, etc. For example, when the captured image includes a decodable dataform, the captured image may be decoded to reveal data encoded in the dataform.

An advantage of the present invention is that it allows a device with an imaging device to provide optimal scanning performance without projecting a targeting pattern onto an object to be captured. This may conserve power for the device. Another advantage of the present invention providing faster image capture and faster decoding and may lower costs by eliminating wasted time due to manually reorienting the device to obtain an enlarged, rotated, centered, etc. view of the object.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
obtaining a first image by an image capture device;
analyzing the first image to detect at least one predetermined object therein;
generating a second image as a function of the first image, the second image including at least one portion of the first image, each of the at least one portion including a corresponding predetermined object;
selecting one of the at least one portion; and
performing a predetermined operation on the selected portion.

2. The method according to claim 1, wherein the image capture device includes at least one of an imager-based scanner, an RFID reader, a mobile phone, a PDA, a digital camera, a digital media player, a tablet computer and a handheld computer.

3. The method according to claim 1, wherein the at least one predetermined object includes at least one of a dataform, a barcode, a shipping label, a graphic and a signature.

4. The method according to claim 1, wherein the image capture device receives signals from a user input arrangement.

5. The method according to claim 4, wherein the user input arrangement includes at least one of a keypad, a keyboard, a touch screen, a trigger, a track wheel, a spatial orientation sensor, an accelerometer, a MEMS sensor, a microphone and a mouse.

6. The method according to claim 4, wherein the signals are generated in response to tactile input, gesture input and voice commands.

7. The method according to claim 4, wherein the selecting includes:
displaying a selector over a first portion of the at least one portion;
moving the selector to a second portion of the at least one portion as a function of the signals received from the user input arrangement; and
selecting the one of the at least one portion upon receipt of a selection signal from the user input arrangement.

8. The method according to claim 7, further comprising:
selecting the first portion as a function of a distance between the first portion and a center of the first image.

9. The method according to claim 8, wherein the first portion is closest to the center.

10. The method according to claim 9, further comprising:
Snapping the selector over the first portion of the first image.

11. The method according to claim 1, wherein the at least one predetermined object in the second image is at least one of rotated, centered and enlarged.

12. The method according to claim 1, wherein the at least one portion is a thumbnail image of the corresponding predetermined object.

13. The method according to claim 1, wherein the predetermined operation is one of (i) storing the selected portion in a memory and (ii) decoding the selected portion.

14. A device, comprising:
an image capture arrangement obtaining a first image; and
a processor analyzing the first image to detect at least one predetermined object therein, the processor generating a second image as a function of the first image, the second image including at least one portion of the first image, each of the at least one portion including a corresponding predetermined object, the processor selecting one of the at least one portion and performing a predetermined operation on the selected portion.

15. The device according to claim 14, further comprising:
a display screen displaying the second image.

16. The device according to claim 14, wherein the at least one predetermined object includes at least one of a dataform, a barcode, a shipping label, a graphic and a signature.

17. The device according to claim 14, further comprising:
a user input arrangement receiving input from a user.

18. The device according to claim 17, wherein the user input arrangement includes at least one of a keypad, a keyboard, a touch screen, a trigger, a track wheel, a spatial orientation sensor, an accelerometer, a MEMS sensor, a microphone and a mouse.

19. The device according to claim 17, wherein the user input includes at least one of tactile input, gesture input and voice commands.

20. The device according to claim 17, wherein the processor displays a selector over a first portion of the at least one portion and moves the selector to a second portion of the at least one portion as a function of the user input.

21. The device according to claim 20, wherein the processor selects the first portion as a function of a distance between the first portion and a center of the first image.

22. The device according to claim 14, wherein the at least one predetermined object in the second image is at least one of rotated, centered and enlarged.

23. The device according to claim 14, wherein the at least one portion is a thumbnail image of the corresponding predetermined object.

24. The device according to claim 14, wherein the predetermined operation is one of (i) storing the selected portion in a memory and (ii) decoding the selected portion.

25. A system, comprising:
an image capture device obtaining a first image; and
a processing device analyzing the first image to detect at least one predetermined object therein, the processing device generating a second image as a function of the first image, the second image including at least one portion of the first image, each of the at least one portion including a corresponding predetermined object, the processing device selecting one of the at least one portion and performing a predetermined operation on the selected portion.

26. The system according to claim 25, wherein the image capture device is one of an imager-based scanner, an RFID reader, a mobile phone, a PDA, a digital camera, a digital media player, a tablet computer and a handheld computer.

27. A device, comprising:
an image capture means for obtaining a first image;
a processing means for analyzing the first image to detect at least one predetermined object therein, the processing means generating a second image as a function of the first image, the second image including at least one portion of the first image, each of the at least one portion including a corresponding predetermined object, the processing means selecting one of the at least one portion and performing a predetermined operation on the selected portion.
